(19) United States
(12) Patent Application Publication
(10) Pub. No.: US 2021/0312023 A1
(43) Pub. Date: Oct. 7, 2021

(54) Agent Login Method, Electronic Device And Storage Medium Based On Voiceprint Identification

(71) Applicant: Ping An Technology (Shenzhen) Co., Ltd., Shenzhen (CN)

(72) Inventor: Bei Qiu, Shenzhen (CN)

(21) Appl. No.: 16/338,957

(22) PCT Filed: Feb. 27, 2018
(86) PCT No.: PCT/CN2018/077375

§ 371 Date: Apr. 2, 2019

(30) Foreign Application Priority Data
Sep. 11, 2017 (CN) 2017108143134

(51) Int. Cl. G06F 21/32; G06F 21/36; G10L 17/06; H04W 4/12

(52) U.S. Cl. CPC G06F 21/32; H04W 4/12; G10L 17/06; G06F 21/36

(57) ABSTRACT

An agent login method based on voiceprint identification, which belongs to a field of login authentication. The agent login method includes receiving login request information initiated by the agent, wherein the login request information includes unique identification information identifying agent identity, verifying whether the agent is a registered agent through the unique identification information, if so, then randomly generating identity review information and providing it to the agent, and prompting the agent to read the identity review information by word-by-word prompt with color changing at constant speed, receiving voice information of the identity review information, and performing voiceprint login verification on the agent according to the received voice information. A login method with double verification of agent identity and voiceprint, and word-by-word prompt with color changing at constant speed to repeat the same, to ensure security of the login of the business system and the accuracy of the verification.

This disclosure declares priority of the Chinese patent application with number 201710814313.4, file on Sep. 11, 2017, entitled “Agent login method, electronic device and storage medium based on voiceprint identification”. Entire content of the Chinese patent application is incorporated in this disclosure by reference.

### BACKGROUND

### 1. Technical Field

This disclosure relates to a technical field of login verification, particularly to a method for agent login based on voiceprint identification, electronic device and storage medium.

### 2. Background Information

Anyone can log in existing business system as long as the account number and password of a valid agent officer can be obtained, and it is impossible to identify whether it is the agent himself who logged on. Once the non-agent get an effective account number and password from the unreasonable channels and logs on the system, it is easy to cause information disclosure, serious threat to enterprise information security, and it is difficult to trace after the information disclosure.

Therefore, how to further improve the security and reliability of business system login, and protect enterprise information security has become an urgent outstanding technical problem.

### SUMMARY

Technical problem to be solved by the present disclosure is to overcome the problem of poor security of the business system login in the prior art, and the present disclosure provides A method for agent login based on voiceprint identification, electronic device and storage medium, which is to ensure the security of the business system login, and then ensures the information security of the enterprise through the double verification of agent identity and voice print.

This disclosure addresses the above technical problem through the following technical solutions:

a method for agent login based on voiceprint identification, which includes steps of: S1, receiving login request information initiated by the agent, wherein the login request information includes unique identification information for recognizing agent identity; S2, verifying whether the agent is a registered agent through the unique identification information, if so, then going to step S3; S3, randomly generating identity review information and providing it to the agent, and prompting the agent to read the identity review information with color changing word-by-word at a constant speed; S4, receiving voice information from agent reading the identity review information; S5, performing voiceprint login verification on the agent according to the received voice information and returning verification result;

an electronic device, comprising a memory and a processor, characterized in that the memory is adapted to store a system for agent login based on voiceprint identification executed by the processor, and the system for agent login based on voiceprint identification comprises: an identity input module, for receiving login request information which includes unique identification information for recognizing agent identity; an identity verification module, for verifying whether the agent is a registered agent according to the unique identification information, and returning verification result; a random information generation module, for randomly generating and displaying identity review information after the identity verification is passed; following read prompt module for prompting the agent to read the identity review information at a constant speed by displaying the identity review information word-by-word with color changing at constant speed; a voice input module, for receiving voice information from agent reading the identity review information; and voiceprint comparison module, for performing voiceprint login verification on the agent according to the voice information, and returning verification result;

a computer readable storage medium, characterized in that the computer readable storage medium stores a system for agent login based on voiceprint identification, which can be executed by at least one processor to achieve the following steps: S1, receiving login request information initiated by the agent, wherein the login request information includes unique identification information for recognizing agent identity; S2, verifying whether the agent is a registered agent through the unique identification information, if so, then going to step S3; S3, randomly generating identity review information and providing it to the agent, and prompting the agent to read the identity review information with color changing word-by-word at a constant speed; S4, receiving voice information from agent reading the identity review information; S5, performing voiceprint login verification on the agent according to the received voice information and returning verification result.

Positive progress effect of the present disclosure lies in: the present disclosure ensures the security of the business system login by double verification on the agent identity and voice print; at the same time, the present disclosure ensures the security of the business system login by adding a function of displaying word-by-word with color changing at constant speed to prompt following read, to ensure that the agent keeps the same speed as possible on following read for each entry, and improve the accuracy of voiceprint login verification.

### BRIEF DESCRIPTION OF THE DRAWINGS

FIG. 1 shows a diagram of hardware architecture of an electronic device according to an embodiment of the present disclosure;

FIG. 2 shows a diagram of program modules of a system for agent login based on voiceprint identification according to a first embodiment of the present disclosure;

FIG. 3 shows a diagram of program modules of a system for agent login based on voiceprint identification according to a second embodiment of the present disclosure;

FIG. 4 shows a diagram of program modules of identity verification module of a system for agent login based on voiceprint identification according to the second embodiment of the present disclosure;

FIG. 5 shows a diagram of program modules of voiceprint comparison module of a system for agent login based on voiceprint identification according to the second embodiment of the present disclosure;

FIG. 6 shows a flowchart of A method for agent login based on voiceprint identification electronic device according to an embodiment of the present disclosure;

FIG. 7 shows a flowchart of A method for agent login based on voiceprint identification electronic device according to another embodiment of the present disclosure;

FIG. 8 shows a flowchart of building a registered agent information database in A method for agent login based on voiceprint identification electronic device according to still another embodiment of the present disclosure;

FIG. 9 shows a flowchart of building a registered agent information database in A method for agent login based on voiceprint identification electronic device according to still another embodiment of the present disclosure.

### DETAILED DESCRIPTION

The present disclosure is further described below by way of embodiments without thereby limiting the present disclosure to the scope of the said embodiments.

First, the present disclosure provides an electronic device.

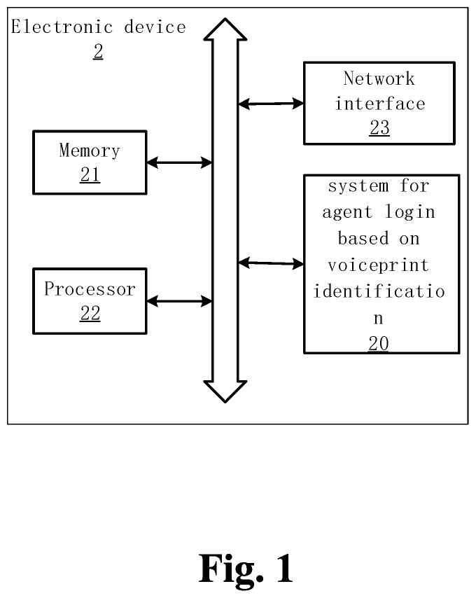

Referring to FIG. 1, a diagram of hardware architecture of an electronic device according to an embodiment of the present disclosure is shown. In this embodiment, the electronic device 2 is a device capable of automatically performing numerical calculations and/or information processing according to predefined or stored instructions. For example, it can be a smartphone, tablet, laptop, desktop computer, rack server, blade server, tower server, or cabinet server including stand-alone servers. Or a cluster of multiple servers), and so on. As shown, the electronic device 2 includes, but is not limited to, a memory 21, a processor 22, a network interface 23 and the a system 20 for agent login based on voiceprint identification that can be communicated with each other through a system bus, in which:

The memory 21 includes at least one type of computer-readable storage medium. The readable storage medium includes flash memory, hard disk, multimedia card, card type memory (e.g., SD or DX memory, etc.), random access memory (RAM), static random access memory (SRAM), read only memory (ROM), electrically erasable. Programmable read-only memory (EEPROM), programmable read-only memory (PROM), magnetic memory, magnetic disk, optical disk, etc. In some embodiments the memory 21 may be an internal storage module of the electronic device 2 such as a hard disk or memory of the electronic device 2. In other embodiments, the memory 21 may also be an external storage device of the electronic device 2, such as a plugged hard disk provided on the electronic device 2, an intelligent memory card (Smart Media Card, SMC), secure digital (Secure Digital, SD) card, a flash memory card (Flash Card), and the like. Of course the memory 21 may also include both an internal storage module and an external storage device of the electronic device 2. In this embodiment, the memory 21 is generally used to store an operating system and various types of disclosure software installed in the electronic device 2 such as the program code of the system 20 for agent login based on voiceprint identification and the like. In addition, the memory 21 may also be used to temporarily store various types of data that have been or will be outputted.

The processor 22 may in some embodiments be a central processor (CPU), a controller, a microprocessor, or other data processing chip. The processor 22 is generally used to control the overall operation of the electronic device 2 such as performing control and processing related to data interaction or communication with the electronic device 2. In this embodiment, the processor 22 is used to run program code stored in the memory 21 or process data such as running the system 20 for agent login based on voiceprint identification or the like.

The network interface 23 may include a wireless network interface or a wired network interface which is generally used to establish a communication connection between the electronic device 2 and other electronic devices. For example, the network interface 23 is used for connecting the electronic device 2 to an external terminal via a network establishing a data transmission channel and a communication connection between the electronic device 2 and the external terminal. The network can be a wireless or wired network such as an enterprise intranet, an Internet, a Global System of Mobile communication (GSM), a Wideband Code Division Multiple Access (WCDMA), a 4G network, a 5G network, a Bluetooth, Wi-Fi, and the like.

It is to be noted that FIG. 1 shows only an electronic device having components 20-23 but it is understood that it is not required to implement all of the shown components and that more or fewer parts can be implemented in lieu thereof.

In this embodiment, the system 20 for agent login based on voiceprint identification stored in memory 21 may also be divided into one or more program modules, said one or more program modules being stored in memory 21, and executed by one or more processors (in this embodiment, processor 22) to complete the present disclosure.

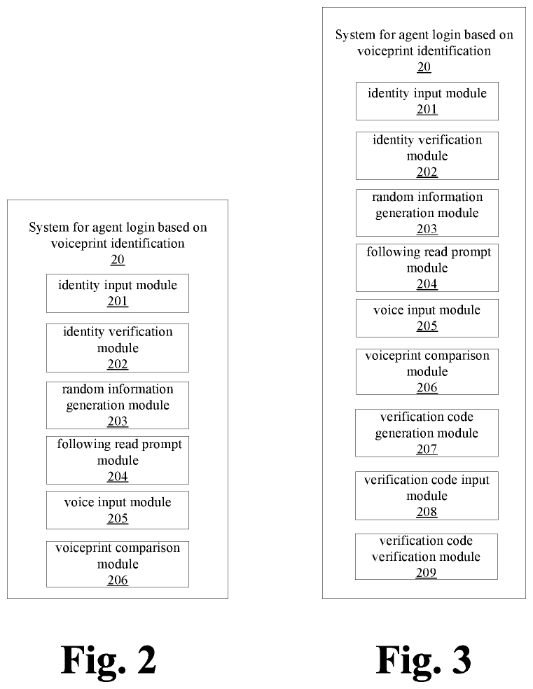

For example, FIG. 2 shows a schematic diagram of a program module of the first embodiment of the system 20 for agent login based on voiceprint identification, in which the system 20 for agent login based on voiceprint identification may be divided into an identity input module 201, an identity verification module 202, a random information generation module 203, a following read prompt module 204, a voice input module 205 and a voiceprint comparison module 206. The specific functions of the program module 201-206 will be described in detail as below.

The identity input module 201 is for receiving login request information which includes unique identification information for recognizing agent identity.

The identity verification module 202 is for verifying whether the agent is a registered agent according to the unique identification information, and returning verification result.

The random information generation module 203 is for randomly generating and displaying identity review information after the identity verification is passed.

The following read prompt module 204 is for prompting the agent to read the identity review information at a constant speed by displaying the identity review information word-by-word with color changing at constant speed.

The voice input module 205 is for receiving voice information from agent reading the identity review information.

The voiceprint comparison module 206 is for performing voiceprint login verification on the agent according to the voice information, and returning verification result.

Use of the system 20 for agent login based on voiceprint identification is conducive to the orderly management of the agent. The following is a description of the use of the system to login to the agent system:

1. The agent clicks on the business system, first enters the agent login system, and the first login page is popped up for inputting unique identification information of the agent, which can be work number of the agent. Following steps take the work number as an example to illustrate; after the system receives the work number, the information inherent in the work number and the work station and other information is combined as the login request information to be sent.

2. Whether the agent represented by the work number is a registered agent is determined according to the work number contained in the login request information, which in particular comprises: determining whether the work number is same as one of the work numbers preset in the registered agent information database; if the preset work number is found in the registered agent information database, returning comparison result representing that agent is registered; otherwise, exiting the login.

3. According to the comparison result that the agent is a registered agent, a second login page is popped up, on which a randomly generated identity check information is displayed, which can be a string of numbers, letters, words or any combination thereof.

4. The agent reads out a string of identity review information according to the word-by-word prompt with color change at constant speed, while the system records the voice information following read by the agent.

5. Voiceprint information is extracted from the recorded voice information, and a voiceprint sample associated with the work number of the agent in the registered agent information database is called out.

6. The voiceprint information is matched with the voiceprint sample; so long as the two are matched to a certain extent, it is determined that the agent is the agent represented by the input work number, and the voiceprint login verification is passed, to allow the agent to enter the business system to continue the operation.

For example, FIG. 3 shows a schematic diagram of a program module of the second embodiment of the system 20 for agent login based on voiceprint identification, in which the system 20 for agent login based on voiceprint identification may be divided into an identity input module 201, an identity verification module 202, a random information generation module 203, a following read prompt module 204, a voice input module 205, a voiceprint comparison module 206, a verification code generation module 207, a verification code input module 208 and a verification code verification module 209.

Functions implemented by the program module 201-206 are the same as the aforementioned first embodiment, which will not be detailed herein; in addition, the functions implemented by the program module 207-209 are as follows.

The verification code generation module 207 is for randomly generating the verification code to be sent to preset mailbox or mobile phone terminal of the agent after the voiceprint login verification fails.

The verification code input module 208 is for receiving verification code inputted by the agent;

The verification code verification module 209 is for verifying the received verification code and returning verification result.

Following is a specific description of the failure of using the system to log on to the agent system.

Following 1-6 in the above example:

7. After the voiceprint login verification is not passed, the system randomly generates a verification code automatically and sends it to preset mailbox or mobile phone associated with the work number of the agent in the registered agent information database.

8. The agent inputs received verification code, and the system compares the received verification code with the verification code sent to the agent, if they are completely consistent, it means that the verification code is verified and passed, to allow the agent to enter the business system to continue the operation; if any corresponding bit of the verification codes received by the system and the verification code sent to the agent is inconsistent, the verification of the verification code is not passed, and the login is terminated.

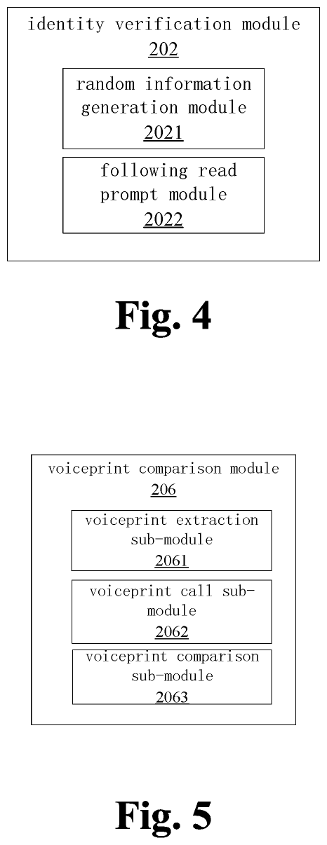

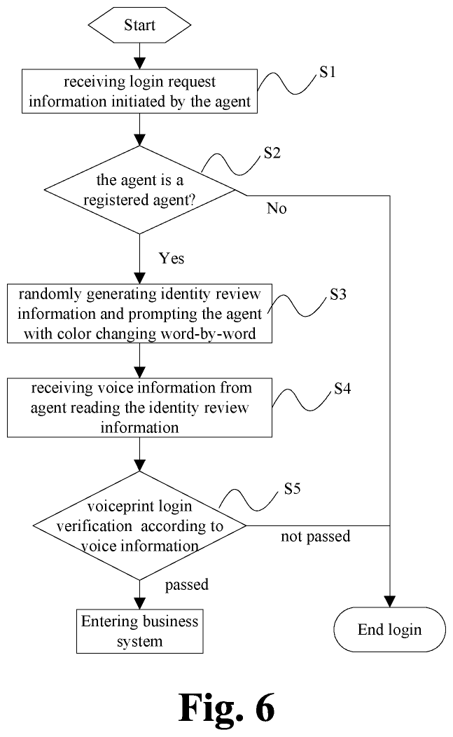

For example, FIG. 4 shows a schematic diagram of program module of identity verification module 202 in the third embodiment of the system 20 for agent login based on voiceprint identification, in which based on the aforementioned second embodiment of the system 20 for agent login based on voiceprint identification, the verification module 202 is further divided into an information interception sub-module 2021 and an identity recognition sub-module 2022.

The program module 2021-2022 achieved the following functions:

the information interception sub-module 2021 is for intercepting unique identification information contained in the login request information;

the identity recognition sub-module 2022 is for comparing the unique identification information with agent information preset in the registered agent information database one-by-one, and returning comparison result.

For example, FIG. 5 shows a schematic diagram of program module of the voiceprint comparison module 206 in the third embodiment of the system 20 for agent login based on voiceprint identification, in which based on the aforementioned second embodiment of the system 20 for agent login based on voiceprint identification, the voiceprint comparison module 206 is further divided into a voiceprint extraction sub-module 2061, a voiceprint call sub-module 2062 and a voiceprint comparison sub-module 2063.

The program module 2061-2063 achieved the following functions:

the voiceprint extraction sub-module 2061 is for extracting voiceprint information from the voice information;

the voiceprint call sub-module 2062 is for finding and calling out the voiceprint sample associated with the agent information which is the same as the unique identification information, from the registered agent information database;

the voiceprint comparison sub-module 2063 is for comparing the voiceprint information with the called out voiceprint sample and returning comparison result.

Further, this disclosure provides A method for agent login based on voiceprint identification.

In an embodiment, the method for agent login based on voiceprint identification includes steps of:

S1, receiving login request information initiated by the agent, wherein the login request information includes unique identification information for recognizing agent identity;

For example, the method for agent login based on voiceprint identification of embodiment of the present disclosure is applied to a business login system, and when an agent opens the business system for login, an account number needs to be entered at the agent end of the business system. The account is converted into login request information and sent to the business login system. When the account number is being converted into the login request information, according to conversion rule, part information in fixed position in the converted login request information is the unique identification information used to identify the agent. Here it can assume that the string consisting of bits 5 through 10 of the login request information is the unique identification information.

S2, verifying whether the agent is a registered agent through the unique identification information, if so, then going to step S3.

Specifically, verifying whether the agent is a registered agent may include the following steps:

S21, intercepting unique identification information for recognizing the agent identity in the login request information;

following the above example, intercepting a 6-bit string consisting of bits 5 through 10 in the login request information;

S22, comparing the unique identification information with agent information preset in the registered agent information database one-by-one.

Said 6-bit string representing the unique identification information is compared with the agent information preset in the registered agent information database, where the length of the agent information is consistent with the length of the unique identification information. In this embodiment, it is assumed that the unique identification information is a string of 6 bits in length so that the length of the agent information must also be assumed to be 6 bits.

S23, if a matching item exists, the verification being passed and going to step S3.

The comparison result can be: when the unique identification information and any agent information in the registered agent information database are identical, character indicating that the agent identity verification is passed is returned, where the character is assumed as 1, and the comparison is end; when the unique identification information has been compared with all the agent information in the registration agent information database one-by-one, and there is still no agent information identical to the unique identification information, character indicating that the agent identity verification is not passed is returned, where the character is assumed as 0. Step S3 is executed only if the comparison result is 1, and the login is terminated when the comparison result is 0.

S3, randomly generating identity review information and providing it to the agent, and prompting the agent to read the identity review information with color changing word-by-word at a constant speed;

Following above example, when returned result is 0, indicating that the agent identity verification is not passed, that is, the agent is not registered agent of the business system and does not have the authority to use the business system, and the login is directly ended;

When the returned result is 1, indicating that the agent identity verification is passed, it means that the agent is a registered agent of the business system, and has right to use the business system, but also needs to login verification by voiceprint identification. As mentioned above, although the agent identity is passed, it is possible that a non-registered agent actually logs on to the business system, but the non-registered agent obtain a valid account of a registered agent through unreasonable channel. If the business system is directly logged in by entering a password for verification, the enterprise information is likely to be disclosed; therefore, after verifying that the agent being logged in is a registered agent, the system will randomly generate identity review information to be provided to the agent for login verification for the agent.

The identity review information may be a number of words, a number of numbers, or a random combination of the words and numbers. For example, the identity review information can be several characters, such as “Welcome logging in to the Business system,” or a few numbers, such as “23059487,” or a combination of several characters and several numbers, such as “good Morning 5768.” The words mentioned here are not limited to any certain type of characters.

After displaying the identity review information and waiting a while, the system automatically changes the color of the identity review information word-by-word at a certain speed, so as to prompt the agent to read the identity review information at a constant speed word-by-word along with the speed of the change of color. Through word-by-word color change at a constant speed, it can effectively indicate the agent to read at the speed as font color change speed, so that the agent read sound more stable, convenient for following voiceprint information comparison. The start time for word-by-word color change can also be designed to be controlled by the agent itself, such as adding a start button near the location where the identity verification information is displayed, and after waiting for the agent to be ready, a start button is clicked, then the identity verification information begins to change color word-by-word.

S4, receiving voice information from agent reading the identity review information;

Following the example above, end time of receiving voice information can be preset in the system because of the manner of prompt following read by changing color word-by-word. For example, voice information is completed received by default in 3 seconds from change of color of the last word of the identity review information, then automatically stopping receipt of voice information. Of course, the end of receiving voice information can also be decided by the agent himself, as long as the end button can be added as the start button as above-mentioned.

S5, performing voiceprint login verification on the agent according to the received voice information.

The voiceprint login verification includes steps of:

S51, extracting voiceprint information in the voice information;

in particular, the voiceprint information is a feature that can characterize a person's characteristics, so that extract voiceprint information herein is to extract features from the received voice information which can represent characteristics of the agent who has read aforementioned identity review information.

S52, searching and calling out in the registered agent information database voiceprint sample associated with the agent information matching the unique identification information;

the voiceprint sample refers to the voiceprint information of registered agent preset in the registration agent information database, a voiceprint sample is associated with a unique agent information and is saved in the registered agent information database.

S53, matching the voiceprint information with the voiceprint sample called out in S52.

In particular, the voiceprint information obtained at present is matched with a voiceprint sample, which belongs to the voiceprint information exclusive to agent identity represented by agent information which is same as the unique identification information.

S54, if the match being passed, determining that the agent passes the login verification.

Following above example, because called out voice sample belongs to the voiceprint information exclusive to agent identity represented by agent information which is same as the unique identification information, when the voice sample information matches with the called out voice sample, it can be determined that the agent logging in to the business system this time is the agent himself represented by the unique identification information; therefore, login verification is passed to allow the agent to enter the business system to continue operation.

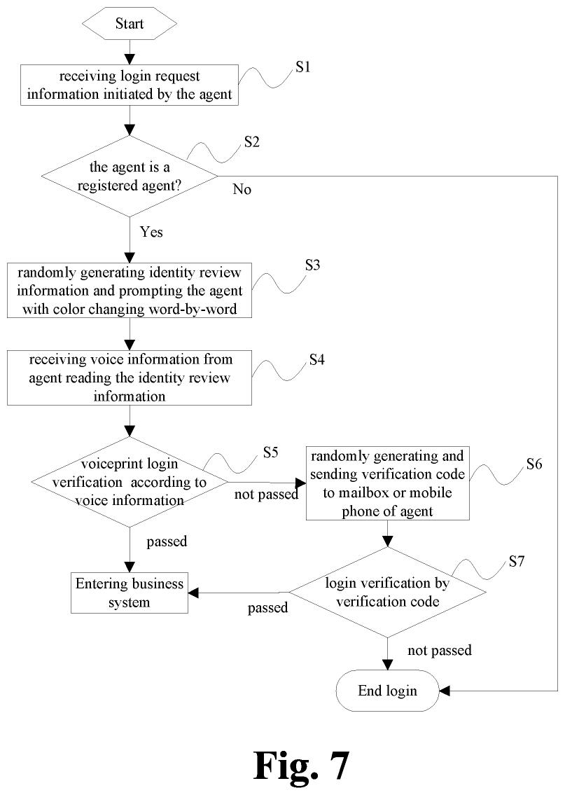

In another embodiment, as shown in FIG. 7, on the basis of the foregoing method, the method for agent login based on voiceprint identification also includes step of the verification code login verification after the voiceprint login is failed, as follows:

S6, after the voiceprint login verification fails, randomly generating and sending verification code to preset mailbox or mobile phone terminal of the agent.

Because every time through the extraction of voiceprint information in the recording to identify personal identity information has a certain error, this error comes from the recording environment or individual voice changes, so voiceprint verification login, it is not required that the voiceprint information and the voice sample match perfectly, usually it is only required that a certain degree of matching should be achieved; even when the matching degree does not reach the preset value, currently logged agent may also be the agent represented by the agent information that is the same as the unique identification information. Therefore, after the voiceprint login verification fails, it can make up for the possible exception of voiceprint login verification by adding the verification code to the login verification.

Verification code login verification is complementary to voiceprint login verification, so that it will not start until entering the voiceprint login verification step and the verification fails. The information associated with the agent information in the registered agent information database is related to the mobile phone number or the mailbox of the registered agent or both in addition to the voice sample. When entering the voiceprint login verification step, it means that the agent has been confirmed as a registered agent through the unique identification information, and once the voiceprint login verification fails, a verification code is generated directly at random, and sent to the mailbox or mobile phone associated with the agent information which is same as the unique identification information. It is necessary to note that the random generation of the verification code here can be set after the voiceprint login verification failed once or three times after the voiceprint login verification failed, that is, the agent will be given the three chances for the voiceprint verification. The generation of verification codes here can also be controlled by the agent, who chooses whether or not to generate and send the verification code.

S7, receiving the verification code and carrying out the verification;

S8, if the received verification code matches with the randomly generated verification code, determining that the agent passes the login verification.

In particular, by comparing the received verification code with the previously randomly generated verification code, if full consistent, the verification is passed, and the agent is allowed to enter the service system to continue the operation; otherwise, the login is ended.

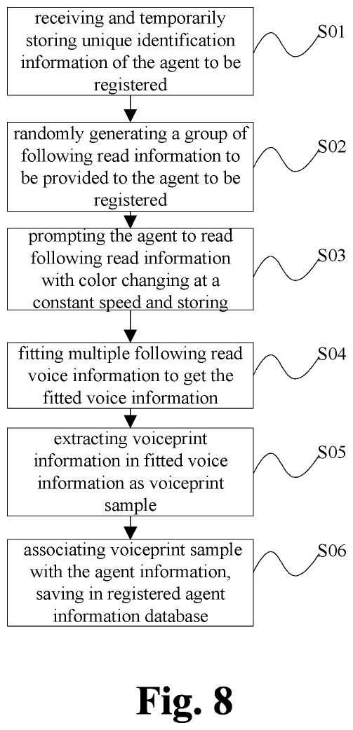

In yet another embodiment, as shown in FIG. 8, on the basis of the foregoing method, the method for agent login based on voiceprint identification also includes step of construction of the registered agent information database prior to entering the login verification, which are as follows:

S01, receiving unique identification information of the agent to be registered, and temporarily storing the unique identification information as agent information of the agent to be registered;

S02, randomly generating a group of following read information to be provided to the agent to be registered;

S03, prompting the agent to be registered to read the following read information at least three times with word-by-word color changing at a constant speed, and temporarily storing following read voice information at multiple times of the agent to be registered;

S04, fitting multiple following read voice information to get the fitted voice information;

S05, extracting voiceprint information in the fitted voice information as voiceprint sample;

S06, associating and saving voiceprint sample with the temporarily stored agent information of the agent to be registered.

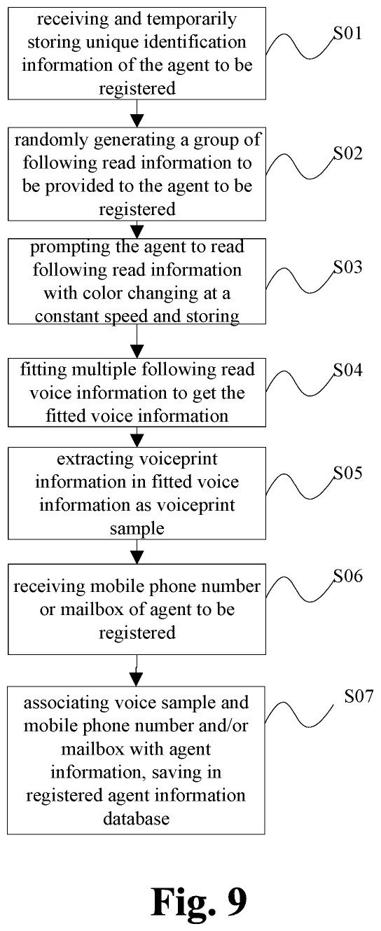

In order to supplement the voiceprint login verification with a verification code login verification after the failure, a further embodiment is proposed on the basis of the aforementioned embodiment, as shown in FIG. 9. Step of construction of the registered agent information database in the method for agent login based on voiceprint identification further includes association of agent information with agent mobile phone number and/or mailbox as follows:

S01-S04 is in accordance with the aforementioned yet another embodiment;

S05, extracting the voiceprint information in the fitted voice information and storing it temporarily as the voiceprint sample;

S06, receiving the mobile phone number and/or the mailbox of the agent to be registered;

S07, associating and saving temporarily stored the voice sample and the mobile phone number and/or the mailbox of the agent to be registered.

Further, this disclosure provides a computer-readable storage medium. The system for agent login based on voiceprint identification system 20 is stored on the computer-readable storage medium. When the system for agent login based on voiceprint identification system 20 is executed by one or more processors, the system for agent login based on voiceprint identification system 20 realizes the operation of the method for agent login based on voiceprint identification or electronic device.

While the specific embodiments of the present disclosure are described above it should be understood by those skilled in the art that the scope of protection of this disclosure is limited by the appended claims only as an example. Without departing from the principles and substance of this disclosure, those skilled in the art may make various changes or modifications to these embodiments, but these changes and modifications fall within the scope of protection of this disclosure.

1. A method for agent login based on voiceprint identification comprising:
step S1, receiving login request information initiated by the agent, wherein the login request information includes unique identification information for recognizing agent identity;
step S2, verifying whether the agent is a registered agent through the unique identification information, if so, then going to step S3;
step S3, randomly generating and providing identity review information to the agent, and prompting the agent to read the identity review information with color changing word-by-word at a constant speed;
step S4, receiving voice information from the agent reading the identity review information; and
step S5, performing voiceprint login verification on the agent according to the received voice information, and returning verification result.

2. The method for agent login based on voiceprint identification as in claim 1, wherein step S2 comprises:
step S21, intercepting unique identification information for recognizing the agent identity in the login request information;
step S22, comparing the unique identification information with agent information preset in the registered agent information database one-by-one; and
step S23, if a matching item exists, the verification being passed and going to step S3.

3. The method for agent login based on voiceprint identification as in claim 2, wherein step S5 comprises:
step S51, extracting voiceprint information in the voice information;
step S52, searching and calling out in the registered agent information database voiceprint sample associated with the agent information matching the unique identification information;
step S53, matching the voiceprint information with the voiceprint sample called out in step S52; and
step S54, if the matching being passed, determining that the agent passes the login verification.

4. The method for agent login based on voiceprint identification as in claim 2 further comprising:
step S6, after the voiceprint login verification fails, randomly generating and sending verification code to preset mailbox or mobile phone terminal of the agent;
step S7, receiving the verification code and carrying out verification; and
step S8, if the received verification code matches with the randomly generated verification code, determining that the agent passes the login verification.

5. The method for agent login based on voiceprint identification as in claim 2 further comprising before step S1:
step S0, building registered agent information database, comprising:
step S01, receiving unique identification information of the agent to be registered, and temporarily storing the unique identification information as agent information of the agent to be registered;
step S02, randomly generating a group of following read information to be provided to the agent to be registered;
step S03, prompting the agent to be registered to read the following read information at least three times with word-by-word color changing at a constant speed, and temporarily storing following read voice information at multiple times of the agent to be registered;
step S04, fitting following read voice information at multiple times to get fitted voice information;
step S05, extracting voiceprint information in the fitted voice information as voiceprint sample; and
step S06, associating and saving the voiceprint sample with the temporarily stored agent information of the agent to be registered.

6.-9. (canceled)

10. A computer readable storage medium, which stores a system for agent login based on voiceprint identification, which can be executed by one or more processors to cause one or more processors to perform following steps:
step S1, receiving login request information initiated by the agent, wherein the login request information includes unique identification information for recognizing agent identity;
step S2, verifying whether the agent is a registered agent through the unique identification information, if so, then going to step S3;
step S3, randomly generating and providing identity review information to the agent, and prompting the agent to read the identity review information with color changing word-by-word at a constant speed;
step S4, receiving voice information from agent reading the identity review information; and
step S5, performing voiceprint login verification on the agent according to the received voice information, and returning verification result.

11. The computer readable storage medium as in claim 10, wherein step S2 comprises:
step S21, intercepting unique identification information for recognizing the agent identity in the login request information;
step S22, comparing the unique identification information with agent information preset in the registered agent information database one-by-one; and
step S23, if a matching item exists, the verification being passed and going to step S3.

12. The computer readable storage medium as in claim 11, wherein step S5 comprises:
step S51, extracting voiceprint information in the voice information;
step S52, searching and calling out in the registered agent information database voiceprint sample associated with the agent information matching the unique identification information;
step S53, matching the voiceprint information with the voiceprint sample called out in step S52; and
step S54, if the matching being passed, determining that the agent passes the login verification.

13. The computer readable storage medium as in claim 11, wherein one or more processors further performs following steps:
step S6, after the voiceprint login verification fails, randomly generating and sending verification code to preset mailbox or mobile phone terminal of the agent;
step S7, receiving the verification code and carrying out verification;
step S8, if the received verification code matches with the randomly generated verification code, determining that the agent passes the login verification.

14. The computer readable storage medium as in claim 11, wherein one or more processors perform the following steps before step S1:
step S0, building registered agent information database, comprising:
step S01, receiving unique identification information of the agent to be registered, and temporarily storing the unique identification information as agent information of the agent to be registered;
step S02, randomly generating a group of following read information to be provided to the agent to be registered;
step S03, prompting the agent to be registered to read the following read information at least three times with word-by-word color changing at a constant speed, and temporarily storing following read voice information at multiple times of the agent to be registered;
step S04, fitting following read voice information at multiple times to get fitted voice information;
step S05, extracting voiceprint information in the fitted voice information as voiceprint sample; and
step S06, associating and saving the voiceprint sample with the temporarily stored agent information of the agent to be registered.

15. The method for agent login based on voiceprint identification as in claim 3 further comprising:
step S6, after the voiceprint login verification fails, randomly generating and sending verification code to preset mailbox or mobile phone terminal of the agent;
step S7, receiving the verification code and carrying out verification; and
step S8, if the received verification code matches with the randomly generated verification code, determining that the agent passes the login verification.

16. The method for agent login based on voiceprint identification as in claim 3 further comprising before step S1:
step S0, building registered agent information database, comprising:
step S01, receiving unique identification information of the agent to be registered, and temporarily storing the unique identification information as agent information of the agent to be registered;
step S02, randomly generating a group of following read information to be provided to the agent to be registered;
step S03, prompting the agent to be registered to read the following read information at least three times with word-by-word color changing at a constant speed, and temporarily storing following read voice information at multiple times of the agent to be registered;
step S04, fitting following read voice information at multiple times to get fitted voice information;
step S05, extracting voiceprint information in the fitted voice information as voiceprint sample; and
step S06, associating and saving the voiceprint sample with the temporarily stored agent information of the agent to be registered.

17. The computer readable storage medium as in claim 12, wherein one or more processors further performs following steps:
step S6, after the voiceprint login verification fails, randomly generating and sending verification code to preset mailbox or mobile phone terminal of the agent;
step S7, receiving the verification code and carrying out verification;
step S8, if the received verification code matches with the randomly generated verification code, determining that the agent passes the login verification.

18. The computer readable storage medium as in claim 12, wherein one or more processors perform the following steps before step S1:
step S0, building registered agent information database, comprising:
step S01, receiving unique identification information of the agent to be registered, and temporarily storing the unique identification information as agent information of the agent to be registered;
step S02, randomly generating a group of following read information to be provided to the agent to be registered;
step S03, prompting the agent to be registered to read the following read information at least three times with word-by-word color changing at a constant speed, and temporarily storing following read voice information at multiple times of the agent to be registered;
step S04, fitting following read voice information at multiple times to get fitted voice information;
step S05, extracting voiceprint information in the fitted voice information as voiceprint sample; and
step S06, associating and saving the voiceprint sample with the temporarily stored agent information of the agent to be registered.
